(19) United States
(12) Patent Application Publication
(10) Pub. No.: US 2016/0167994 A1
(43) Pub. Date: Jun. 16, 2016

(54) TREATMENT OF WASTE WATER

(71) Applicant: THE COUNCIL FOR SCIENTIFIC AND INDUSTRIAL RESEARCH (CSIR), Pretoria (ZA)

(72) Inventors: Paul Johan Oberholster, Western Cape (ZA); Po-Hsun Cheng, Western Cape (ZA)

(21) Appl. No.: 14/567,695

(22) Filed: Dec. 11, 2014

(51) Int. Cl. C02F 3/32

(52) U.S. Cl. CPC C02F 3/322; C02F 2101/10

(57) ABSTRACT

A biological process for treating metal- and/or sulphate-containing waste water includes introducing at least one macroalgal species selected from Klebsormidium acidophilum, Microspora quadrata and Oedogonium crassum, into a body of water. Waste water is introduced into the body of water. In a water treatment stage, the macroalgal species are allowed to biosorb at least one metal and/or at least one sulphate from the waste water, thereby to bioremediate the waste water.

THIS INVENTION relates to the treatment of waste water. It relates in particular to a biological process for treating metal- and sulphate-containing waste water, particularly acid mine drainage (‘AMD’).

Properties of AMD render receiving water resources less habitable to various biotas; also, waters that receive AMD are often characterized by very low biodiversity, and the flora and fauna become dominated by highly resistant organisms and acidophilic biota. Due to the toxicity effects accompanying AMD, sensitive species are systematically reduced or eliminated, e.g. through a failure to reproduce, reduced feeding ability and other adverse physiological and health effects, which also alter the ecological interaction such as prey-predator relations. It is known that the reduction in aquatic animal biodiversity in waters that receive AMD result in these systems becoming dominated by acid-loving (acidophilic) organisms. In severe cases of AMD contamination, all biota except for a few species of bacteria die off.

Conventional AMD treatment systems, which are most commonly used at abandoned mine sites, require continual addition of expensive chemicals such as lime, which generate huge volumes of low density sludge. The disposal of this sludge creates an environmental problem, and is an additional cost. Conventional treatment processes are often expensive in terms of both capital and operational costs. For example, the very high acidity of AMD water results in higher operating costs, associated with the shorter life-time and more frequent replacement of consumables such as filters and ion-exchange resins.

During the last three decades, passive treatment of AMD using technologies such as constructed wetlands has been developed as an alternative to conventional treatment. Biological metal removal is an important pathway for metal removal in these wetlands. Probably the most widely recognized biological process for metal removal in wetlands is macrophyte uptake. However, metal storage capability of macrophytes in constructed wetlands for AMD treatment can be lost in temperate regions during winter months when plant metabolic processes are reduced due to lower water temperatures. Adsorption of metals by algae is highly variable depending on the metals, and the algal taxon. Many heavy metals are necessary micronutrients to algae in low concentrations; however, at high concentrations those can be fatal. Metal toxicity to algae occurs by affecting their essential metabolic processes through protein denaturation by the blockage of functional groups, displacing an essential metal, or by rupture of cellular and organelle membrane integrity. Under unfavourable environmental conditions, algae respond by the induction of reactive oxygen species (ROS) producing enzymes like glutathione S-transferase (GST), superoxide dismutase, catalase and peroxidase. High metal concentration leads to ROS production up to intolerable ranges causing damage of the algae cells.

It is thus an object of this invention to provide a biological process for treating metal- and/or sulphate-containing waste water, whereby metals and/or sulphates can be extracted effectively from the water.

Thus, according to a first aspect of the invention, there is provided a biological process for treating metal- and/or sulphate-containing waste water, the process including
introducing at least one macroalgal species selected from Klebsormidium acidophilum, Microspora quadrata and Oedogonium crassum, into a body of water;
introducing the waste water into the body of water; and
in a water treatment stage, allowing the macroalgal species to biosorb at least one metal and/or at least one sulphate from the waste water, thereby to bioremediate the waste water.

The waste water may, in particular, be acid mine drainage (AMD) which typically has a pH of 3 to 4. AMD usually contains both dissolved metals such as Al, Fe, Mg, Mn and Zn and dissolved sulphate. Thus, in accordance with the present invention, both dissolved metals and dissolved sulphates are removed from AMD.

The body of water may be provided downstream of at least one other water treatment stage. Thus, two other water treatment stages may be provided. Untreated AMD may then be subjected, in a first of the water treatment stages, to primary treatment to remove some dissolved metals therefrom. The AMD from the first water treatment stage may then be subjected, in a second of the water treatment stages, to secondary treatment to remove further dissolved metals therefrom, with the resultant partially treated AMD may then pass from the second treatment stage into the body of water. The biosorption of the at least one metal and the at least one sulphate will thus constitute tertiary treatment of the AMD.

The primary treatment may comprise raising the pH of the AMD, typically to about 5 to 7, to precipitate and insolubilize a high proportion and even most of the metals present in the AMD. Thus, the primary treatment may comprise passing the AMD through a neutralization stage where the pH is raised by lime treatment of the AMD.

The secondary treatment may comprise passing the metal-depleted AMD from the neutralization stage through a wetland for further removal of metals therefrom, with the wetland thus constituting the second of the water treatment stages. The wetland may be a constructed artificial wetland.

The tertiary treatment may be effected in an algal polishing pond which thus provides the body of water in which the treatment with the K. acidophilum, M. quadrata and O. crassum takes place, to remove dissolved metals and sulphates from the partially treated AMD that enters the polishing pond.

The macroalgal concentration in the algal polishing pond may be maintained at about 1×10⁵ cells/i.

The residence time of the partially treated AMD in the algal polishing pond may be at least one hour, preferably from 1 to 100 hours, more preferably from 24 to 96 hours.

The water in the algal finishing pond will naturally be at ambient temperature which, for summer months, can typically be in the region of 20° C. to 25° C., and for winter months, less than 15° C., e.g. about 13° C. to 14° C. K. acidophilum, M. quadrata and O. crassum are all effective in reducing metal and sulphate levels in the partially treated AMD during both summer and winter.

According to a second aspect of the invention, there is provided a biological process for treating acid mine drainage (AMD), the process including
subjecting, in a first water treatment stage, AMD to primary treatment to remove dissolved metals therefrom;
subjecting the AMD from the first water treatment stage, to secondary treatment in a second water treatment stage, to further remove dissolved metals therefrom; and
introducing the resultant partially treated AMD into a body of water containing at least one macroalgal species selected from Klebsormidium acidophilum, Microspora quadrata and Oedogonium crassum, for tertiary treatment of the AMD to remove dissolved metals and sulphates therefrom.

The first, second and third water treatment stages, and hence the primary, secondary and tertiary treatments, may be as hereinbefore described for the first aspect of the invention.

The invention will now be described in more detail with reference to the following non-limiting example and the accompanying drawings.

In the drawings,

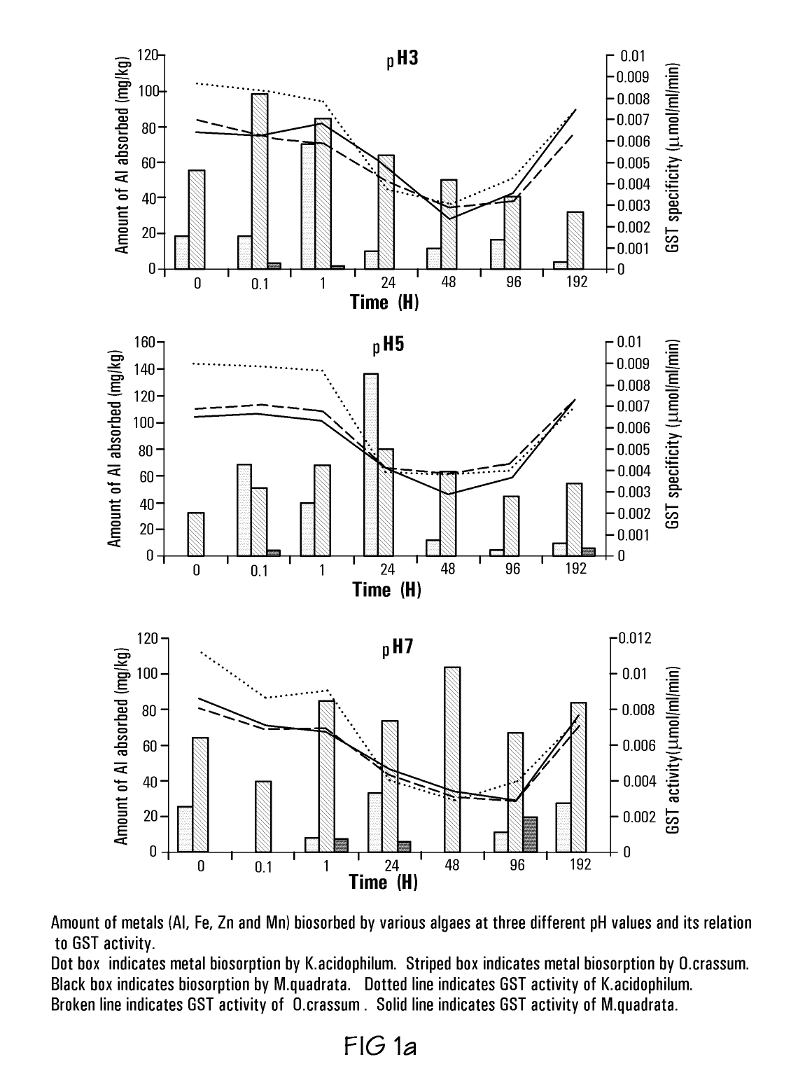

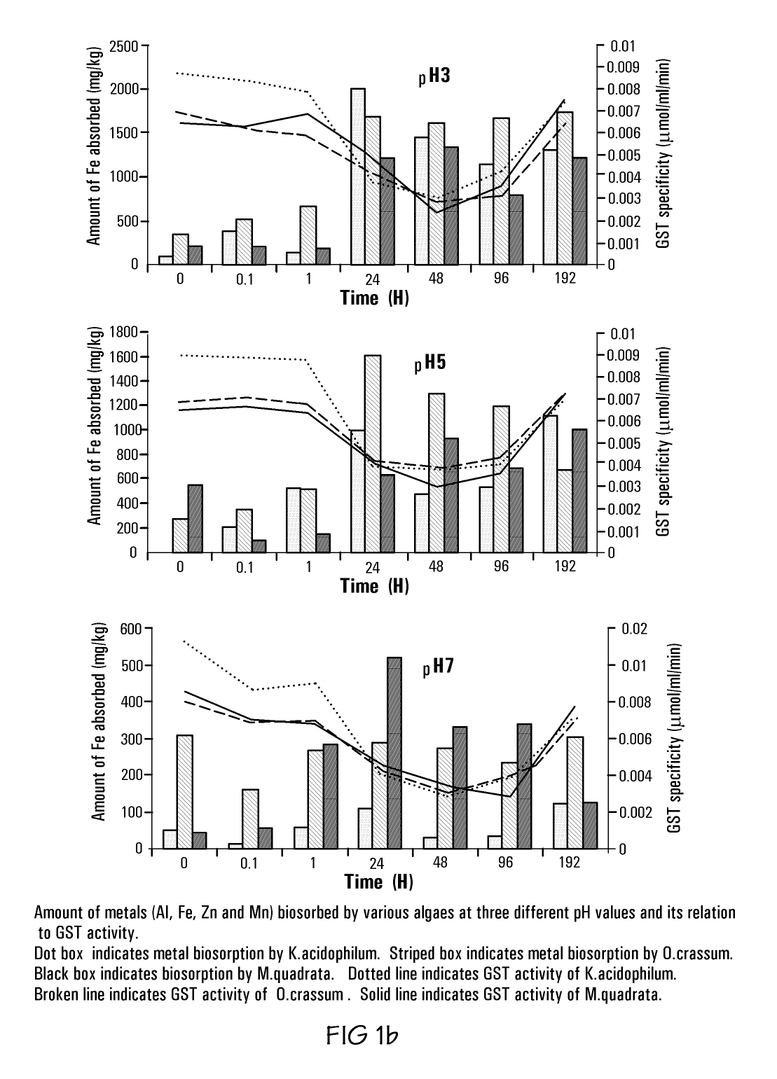

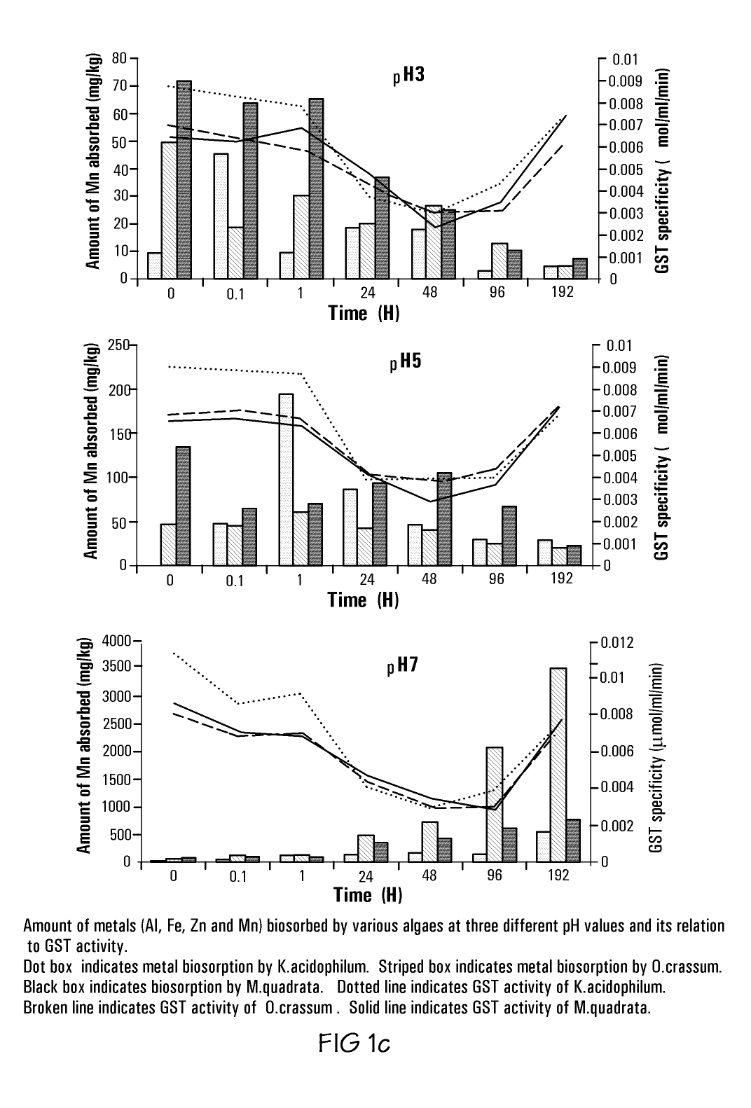

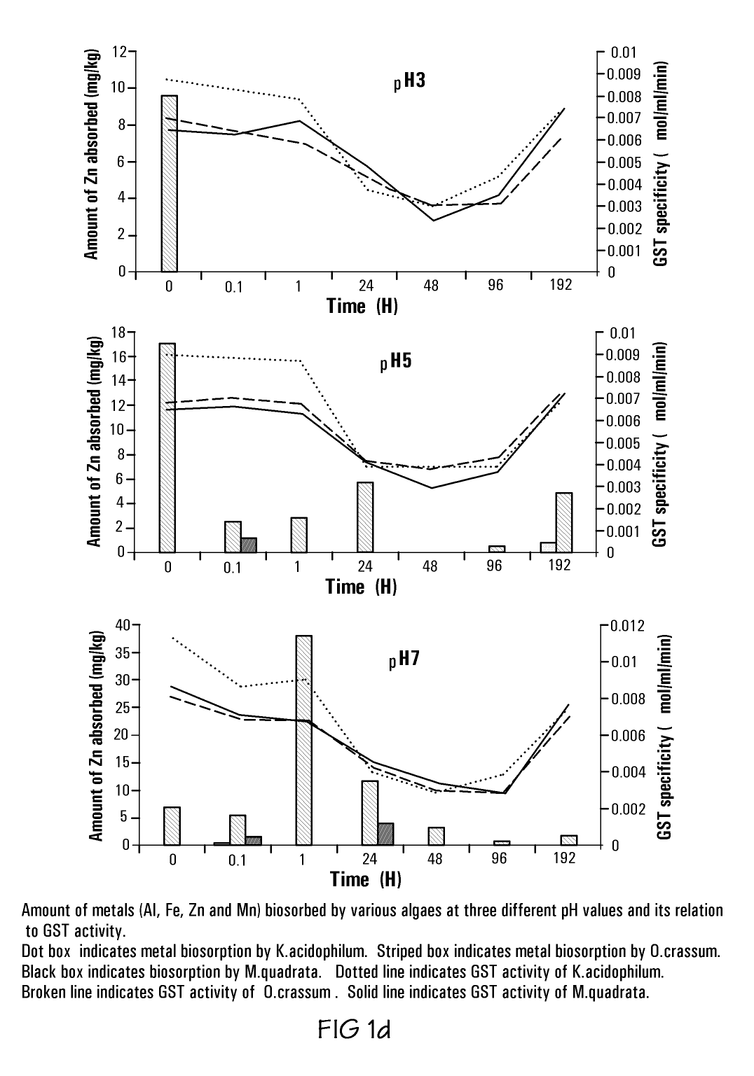

FIGS. 1(a)-(d) show, for the Example, the amount of metals (Al, Fe, Mn and Zn) biosorbed by the various macroalgal species at three different pH values and their relation to GST activity;

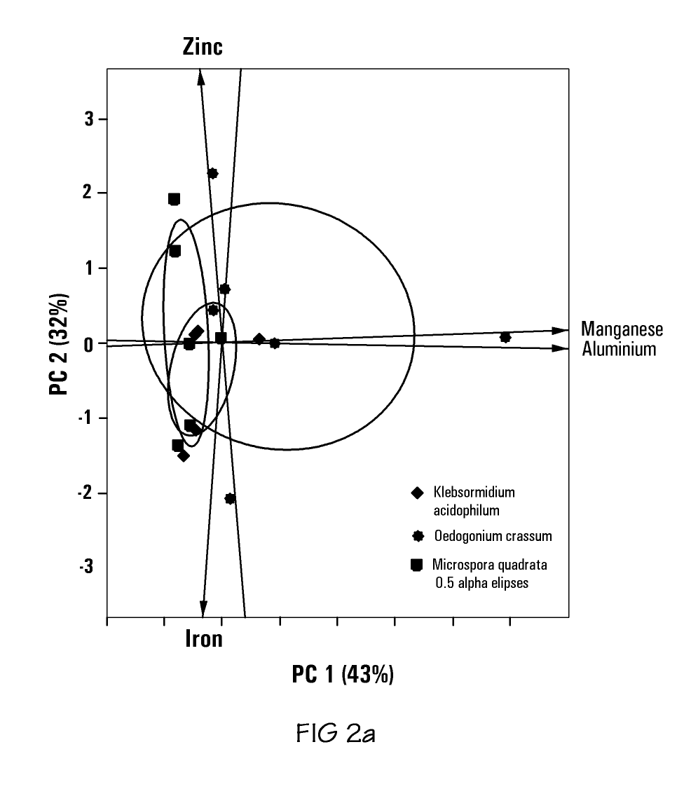

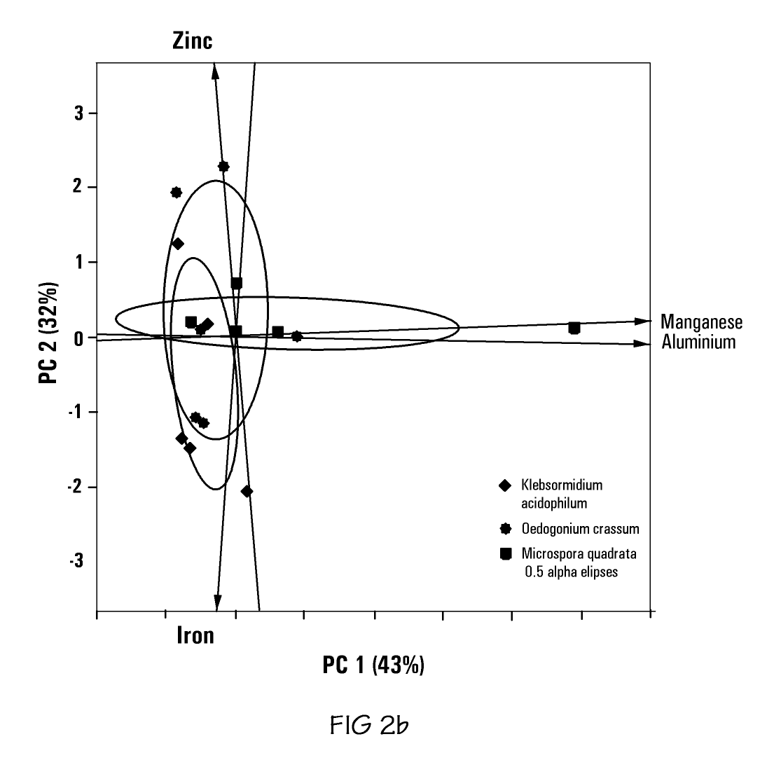

FIGS. 2(a) and (b) show, for the Example, Principal Component Analysis plots of metal absorption, with (a) showing algal absorption with different metals, and (b) showing metal absorption under different pH conditions;

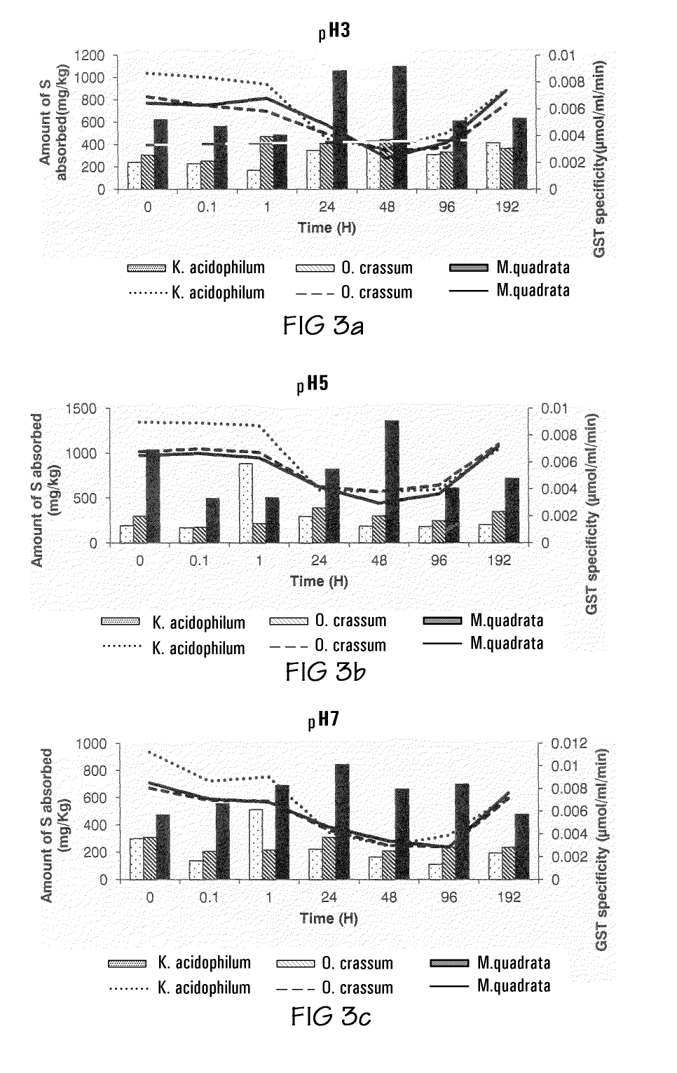

FIGS. 3(a)-(c) show, for the Example, plots of amounts of sulphur biosorbed by algae at three different pH values and their relation to GST activity, with (a) being ph3, (b) being pH5 and (c) being pH7;

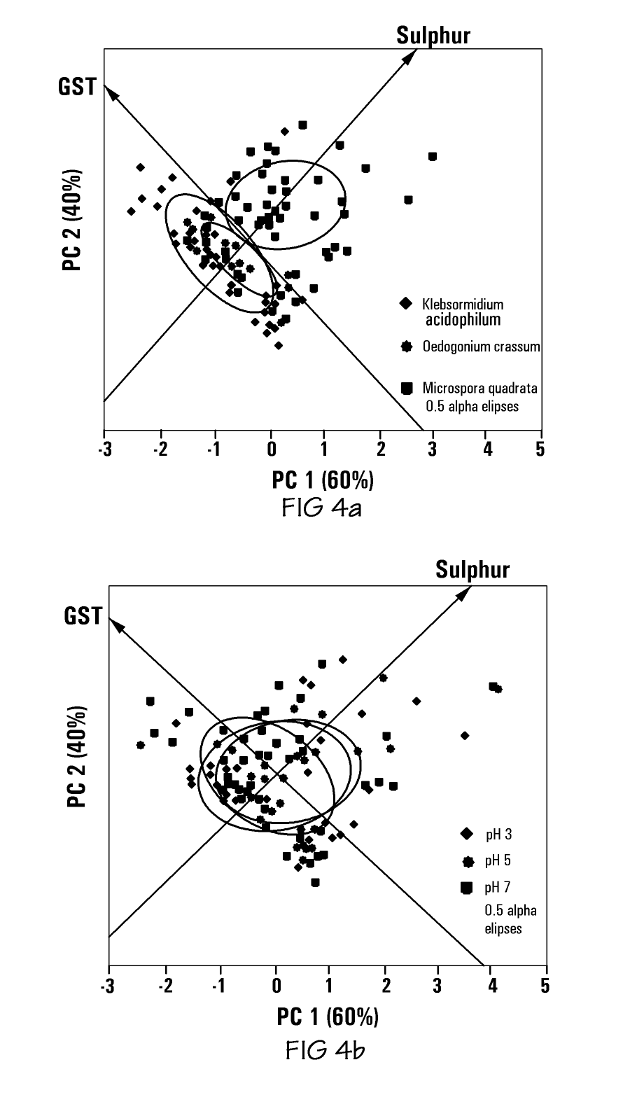

FIGS. 4(a) and (b) show, for the Example, Principal Component Analysis plots of sulphur absorption, with (a) showing algal absorption of sulphur and (b) showing sulphur absorption under different pH conditions; and

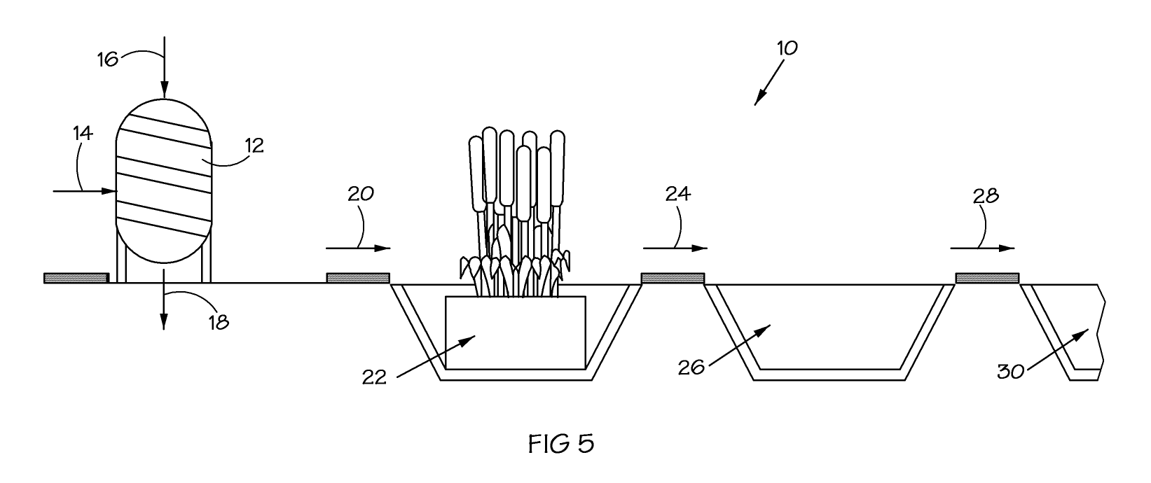

FIG. 5 shows, schematically, a constructed wetland incorporating an algal polishing pond as secondary passive treatment in accordance with the invention.

### EXAMPLE

### Objectives

It is known that algae metal content increases with an increase in metal content of the surrounding water. Therefore, the presence and tolerance of diverse benthic algal species to AMD provides the option to utilize them as part of AMD passive bioremediation technology in winter months when metal biosorption efficiency by constructed wetland plants are reduced. The objectives were (1) to determine the biosorbsion of sulphates and metals in different macroalgal species under winter field conditions at AMD impacted sampling sites (2) to perform laboratory studies on isolated macroalgal species by determining the biosorpsion of selected macroalgal at different pH values under constant low water temperature (in winter months the metabolism of microbials and macrophyte plants are reduced and uptake of metals is much lower), (3) to determine through time trials the levels of glutathione S-transferase, an antioxidant enzyme, activity at different pH values, to determine if the algae growth conditions were effected, and (4) to establish which of the selected macroalgae or a combination thereof would be the best candidates to be used as a tertiary treatment strategy in macroalgal treatment ponds.

Epilithic Filamentous Algae Sampling and Identification

Epilithic filamentous macroalgae mat samples were collected from cobbles and boulders at the selected AMD impacted sites. The focus was on collecting macroalgae rather than microalgae due to the difficulties associated with harvesting microalgae in bioremediation algal ponds. A known area (5 cm in diameter) of cobble or boulder surfaces was isolated with a cylindrical open ended Plexiglas tube fitted with a basal neoprene seal; the area was scraped with brushes after squirting 100 ml stream water into the jar. The resultant algal slurry was pulled from the tube chamber with a syringe extended with a tygon tube (Douglas 1958; Hauer and Lamberti 2006). Five discrete epilithic macroalgae samples were collected at each site and combined into a composite sample. Epilithic macroalgae samples (5%) were preserved in the field by addition of 2.5% calcium carbonate-buffered glutaraldehyde while the rest was used for metal biosorption analyses and cultivation of axenic macroalgae strains.

On site preservation of samples was carried out according to Clesceri et al. (1998). Macroalgae were identified microscopically using a Zeiss AX compound microscope at 1250× magnification (Truter, 1987; Van Vuuren et al., 2006). Aliquots (10-100 ml) were sedimented depending on the abundance of the filamentous algae in the samples. Strip counts were made until at least 100 individuals of each of the dominant macroalgal species had been counted (American Public Health Association, 1992). Epilithic macroalgae abundance in the samples was determined by counting the presence of each species (as cells in a filament or equal number of individual cells).

Metal Accumulation Analysis of Field Samples

All macroalgae samples were stored in acid washed polyethylene bottles at 4° C. and kept in the dark during transfer from the field to the laboratory. Macroalgal samples were rinsed three times with 1 N HCl and deionised water to remove surface metals and debris after which samples were dried to constant weight at 60° C. Triplicate subsamples (50-100 mg dry weight) were digested in concentrated nitric acid to extract metals, which were then determined by inductively coupled plasma atomic emission spectroscopy (ICP-AES). Sample-based standards were used as described by Jugdaohsingh et al. (1998).

Physical and Chemical Variables

Water temperature, pH and electrical conductivity were measured in situ at each sampling site using a Hach Sension™ 156 portable multiparameter (obtained from Loveland, USA). Water samples for chemical analyses were collected in 1 litre acid clean polyethylene bottles. At the stream site, the bottles were rinsed once with stream water before collection of the final sample. On return to the laboratory, water samples were filtered through 1 μm Gelman glass fibre filters and preserved in nitric acid, after which total metals were determined by ICP-AES.

Bioconcentration Factor

The bioconcentration factor (BCF) which is the ratio of the chemical concentration in the organism to the water column was calculated using the equation BCF=Cb/Cw where Cb=concentration of elements in the dry algal biomass (mg·kg⁻¹) and Cw=concentration of elements in the water (mg·l⁻¹).

Laboratory Experiments

Cultivation of Axenic Macroalgae

From the microscopic analyses of the macroalgae mats collected at the four field sampling sites, three macroalgae species namely K. acidophilum (site 3), M. quadrata (site 4) and O. crassum (sites 1 and 2) were chosen. The different macroalgae mats were centrifuged and washed with sterile PBS (Phosphate Buffered Saline) thrice. To establish axenic cultures, petri dishes with the different collected macroalgae mats were placed under a dissecting microscope and filaments of the dominant macro algae were isolated and washed again with sterile PBS (pH 7.5; obtained from Lonza, Switzerland) buffer containing 10 mg·l⁻¹ germanium dioxide thrice. After the different algal filaments were isolated and washed, they were placed into 100 ml of algae culture broth (obtained from Sigma-Aldrich Chemie GmbH, Switzerland) medium supplemented with 10 mg·l⁻¹ germanium dioxide to inhibit diatom growth that could have attached to filamentous macroalgae. To verify if the macroalgae cultures were axenic a compound microscope at 1250× magnification were used to examine the different cultures every 3 days; if the cultures were not axenic the procedure was repeated.

After axenic cultures were established, the three different algae M. quadrata, O. crassum and K. acidophilum were filtered and their wet biomass determined prior to inoculation to the growth medium. Nine sterile conical flasks were used to pour 100 mg of the different stock axenic macroalgae cultures into 900 ml of sterilized algae culture broth (obtained from Sigma-Aldrich Chemie GmbH, Switzerland). For each macroalgal culture, triplicate flasks were set up. Flasks were shaken at 100 rpm and surrounded by eight tubular cool white fluorescent lamps, providing ˜9000 lux illumination. Light was set to 12:12-h light—dark cycles and water temperature was kept at 14° C. (average water column temperature in the winter months of field sampling sites). The growth rate of algal biomass was expressed relative to total chlorophyll and was measured over a 192 h period according to standard procedures of Porra et al. (1989).

Exposure studies were conducted in triplicate; stock macroalgae samples were exposed to AMD (pH 3) water collected from Site 4 (Table 1) and NaOH treated AMD (pH 5 and pH 7) also from Site 4. In the control, macroalgae were exposed to saline (NaCl) at a pH of 3, 5 and 7. The experiment was run over a period of 192 hours (samples were collected at the following exposure, times 0 h, 0.1 h, 1 h, 24 h, 48 h, 96 h and 192 h).

TABLE 1
Biosorption and water chemistry characteristics of locations samples in winter (field experiment)

| Location | | Site 1, Klip stream | | Site 2, Brug stream | | Site 3, Blesbok stream | | Site 4, Grootstream | |
|---|---|---|---|---|---|---|---|---|---|
| Co-ordinate | (lat, long) | S25° 37.290′ | E29° 12.752′ | S25° 51.424′ | E29° 08.139′ | S26° 11527′ | E27° 72314′ | S26° 11110′ | E27° 72273′ |

| | | | | | |
|---|---|---|---|---|---|
| Substrate tape | | Cobbles, boulders | Cobbles boulders | Cobbles | Cobbles boulders |
| AMD source | | Decanting surface flows | Seepage from decanting | Decanting water from | Decanting surface flows |
| | | from coal mines | coal mines forming | coal mine | from coal mines |
| | | | a stream | | |
| Stream cross- | (m²) | 6~9 | 2~3 | 5~7 | 2~4 |
| sectional area | | | | | |
| pH | | 3.2 | 3.1 | 3.4 | 2.9 |
| Temperature | (° C.) | 14 | 13 | 14 | 14 |
| Depth | (cm) | 25 | 21 | 18 | 22 |
| Al | Algae biosorption | 14406 | 46292 | 18867 | 2143 |
| | (mg · kg⁻¹ d · wt) | | | | |
| | Water column | 4.33 | 4.83 | 0.14 | 3.9 |
| | Chemistry | | | | |
| | (mg · L⁻¹) | | | | |
| Fe | Algae biosorption | 24325 | 37280 | 34051 | 401739 |
| | (mg · kg⁻¹ d · wt) | | | | |
| | Water column | 0.288 | 9.7 | 79 | 8.67 |
| | Chemistry | | | | |
| | (mg · L⁻¹) | | | | |
| Mn | Algae biosorption | 184 | 4195 | 1629 | 3586 |
| | (mg · kg⁻¹ d · wt) | | | | |
| | Water column | 2.45 | 3.21 | 51 | 17.86 |
| | Chemistry | | | | |
| | (mg · L⁻¹) | | | | |
| Zn | Algae biosorption | 24 | 84 | 143 | 146 |
| | (mg · kg⁻¹ d · wt) | | | | |
| | Water column | 0.23 | 0.633 | 0.26 | 3.9 |
| | Chemistry | | | | |
| | (mg · L⁻¹) | | | | |

Glutathione S-Transferase (GST) Activity Assays for Each Algae Species Under Various pH Treated Condition

Glutathione S-transferase (GST) was selected as a biomarker to monitor oxidative stress induced in macroalgae species under AMD conditions at different pH values over a period of 192 hours. GST is commonly used as a biomarker for its ability to inactivate toxic compounds that can induce oxidative stress in organisms (Swain 1977; Regoli 2012; Vera-Lopez et al 2013).

Fresh macroalgae cultures from the different macroalgae treated with saline and AMD (pH 3, 5 and 7) before and after exposure (0 h, 0.1 h, 1 h, 24 h, 48 h, 96 h, 192 h) were harvested by centrifugation at 4 000 g. The macroalgae pellets were washed thrice by re-suspending in 1 ml of ice cold phosphate buffered saline (pH 7.5; obtained from Lonza, Switzerland) and centrifuged at 4 000 g in 4° C.; after washing, the macroalgal pellets were reconstituted with 500 ml of ice cold Dulbecco's Phosphate Buffered Saline (obtained from Sigma-Aldrich Chemie GmbH, Switzerland) for the subsequent homogenization. Each macroalgal sample was homogenized using sonication, samples were kept on ice at 4° C. then sonicated using Banson sonifier 3×60 pulse cycle. Sonicated algal tissues were spun at 13 000 g for 15 min at 4° C. The supernatant was then transferred into new eppendorf tubes and kept on ice. Protein concentration was determined using a Bio-Rad (obtained from Bio-Rad, Laboratories GmbH, Munich, Germany) protein assay with bovine serum albumin as the standard according to the manufacturer's instructions and adjusted to 0.1 mg·ml⁻¹ for all samples.

The GST assay was performed as described by the Sigma manual (obtained from Sigma-Aldrich Chemie GmbH, Switzerland). GST activity was assessed at each time interval and at each selected pH value by monitoring the increase in absorbance at 340 nm, at 25° C. for 5 min (Mozer et al., 1983). 200 ml⁻¹ of reaction mixture was obtained by adding Dulbecco's Phosphate Buffered Saline; CDNB (1-chloro-2,4-dinitrobenzene) (5 mM final concentration); reduced glutathione: GSH (10 mM final concentration) and the enzyme extract (2 μg protein). GST activity was calculated as μmol CDNB conjugate ml⁻¹·min⁻¹ of protein (extinction coefficient, εmM: 9.6 M·cm⁻¹ and path length was 0.552 cm) after subtracting the Δ340 min⁻¹ for the blank reaction from the Δ340 min⁻¹ for each sample reaction.

ICP-MS Analysis

For ICP-MS analysis both control and exposed algae were centrifuged at 13 000 g for 2 min at 4° C. Macroalgae pellets were collected and washed with sterile Milli Q water and spun at 13 000 g for 1 min at 4° C., the washing step was repeated thrice and the excess supernatant was removed with a pipette.

The macroalgae samples were separately placed in vials and weighed using a calibrated Analytical balance ΔE163. Using a verified micropipette, 2 ml concentrated 69% HNO₃ was added to each vial and left for cold digestion for 24 hours. After 24 hours 1 ml of concentrated HCl acid was added. The vials were placed in a water bath at a temperature of 60° C. until all visible particles dissolved in the acid. Samples were cooled to room temperature. The digested macroalgae were decanted into an ICP tube and made up to a final volume of 10 ml with Milli Q water. The vials were cleaned, dried and weighed. The actual mass of the macroalgae was calculated by subtracting the mass of the empty vial from the mass of the vial containing macroalgae. Digested different macroalgae samples were filtered into an ICP-MS sample cup using a 0.45 um syringe filter. The sample was analysed using an Agilent 7500cx quadrupole Inductively Coupled Mass Spectrometer using Mass hunter software. Calibration standards ranging from 1 ppb to 100 ppb were prepared in 2% acid.

For the analysis of selected trace metals in biological tissue the method was adapted from Jones and Laslett (1994). Data was calculated and processed automatically using the Analysis Batch Mass hunter software. The mass and volume of the macroalgae was then used to convert the results from μg·l⁻¹ to μg·kg⁻¹.

Statistical Analysis of Cultured Macroalgal Experiments

All variables, except pH, were previously log-transformed to reduce skewed distributions. Two way ANOVA (site and time) was used to determine physicochemical and biological differences: (i) among algae, (ii) between time and (iii) different pH having different temporal variations. To perform this analysis, parameters with three replicates per sampling time were used.

Homogeneity of variances and normality of data were checked prior to data analysis. If significant differences were found (p<0.05), the ANOVA was followed by a Tukey-b test. Pearson correlations were performed in order to explore the relation between GST and between metals. All these analyses were done with SPSS v15.0 software.

Multivariate analyses were performed based on the macroalgae differences based on GST activity, metal biosorption and the corresponding time measured. This was done using the CANOCO software version 4.5 (Ter Braak and Smilauer, 2002).

Parameters for various algae have different magnitudes and scales of measurements so it is necessary to standardize the data to produce a normal distribution of all variables (Davis, 1973). Dimensionality and information ordination of the data set were converted to numerical mean and variance of one, by subtracting from each variable the mean of the data set and dividing by the standard deviation without reducing or minimizing on losing the meaning. The initial factor from correlation matrix of the data was extracted by principal component (PC) extraction using programme R (version 3.0.1; 2013). The characteristic roots (eigenvalues) of the PCs were a measure of their associated variances, and the sum of eigenvalues coincides with the total number of variables.

### Results

A significant correlation was observed between metal concentrations among macroalgae and water and among different metal concentrations in algae. The Fe concentrations in the macroalgae correlated negatively (p≦0.003) with the Fe in the water column suggesting biosorption of metals. There were no significant statistical differences between the GST activity and K. acidophilum, M. quadrata and O. crassum at the pH values 3, 5 and 7. However, decreased GST activity was observed in the macroalgae at all three selected pH values within the first 48 hours of exposure, while GST activity increased after 48 hours to 192 hours in all three macroalgae, as shown in FIG. 1. In the saline control (absence of metals) K. acidophilum, M. quadrata and O. crassum were subjected to identical conditions as mentioned above. AMD exposure as well as GST activity was monitored. From FIG. 1, it can be seen that there is no significant difference among K. acidophilum, M. quadrata and O. crassum under the three different pH values. However, there was a substantial increase of GST activity after 48 to 96 hours (p<0.00001) between AMD exposure and the saline exposure (results not shown).

After exposure of 192 hours to AMD at different time intervals and different selected pH values the most efficient macroalgae to sequestrate the selected metals (Al, Fe, Mg, Mn, Zn) were determined in the following order: O. crassum>K. acidophilum>M. quadrata. The order of biosorption of Al by macroalgae at a pH of 7 was as follows O. crassum>K. acidophilum>M. quadrata while at a pH 3 and 5 a similar order to pH 7 was observed (FIG. 1a). However, it was evident that as the pH decreased, metal biosorption in the macroalgae decreased as well.

The most efficient biosorption of Fe was observed within the first 96 hours and after 192 hours at a pH of 7 by macroalgae M. quadrata. Both O. crassum and K. acidophilum showed an increase in biosorption as time progressed (FIG. 1b). At a pH value of 5, Fe biosorption increased in all three macroalgae in comparison to a pH of 7. Initial biosorption of Fe, within the first 96 hours was in the following order O. crassum>M. quadrata=K. acidophilum while changes in algae biosorption occurred after 96 hours: K. acidophilum=M. quadrata>O. crassum (FIG. 1b). Biosorption of Fe at a pH of 3 increased after 48 hours of exposure, reaching a maximum algal biosorption in the following order of O. crassum>K. acidophilum>M. quadrata (FIG. 1b).

The amount of Mn biosorption by macroalgae at pH of 7 increased considerably in comparison to a pH of 5 and 3 (FIG. 1c). At pH 7 the following order was observed O. crassum>M. quadrata˜K. acidophilum (p<0.003212, FIG. 1c). At pH 3 and 5, no significant differences in biosorption of Mn among the three macroalgae species were observed (FIG. 1c). In the case of Zn, biosorption efficiencies among macroalgae species were as follows: O. crassum>K. acidophilum˜M. quadrata (p<0.000001). As pH decreased the amount of Zn biosorption also decreased in all three algal species (p<0.037992, FIG. 1d).

The association phenomena between algae species to metals at different pH are unique and specific, as seen from FIG. 2. Association phenomena were analysed through principle component analysis. The ordination plot describes 75% of the variation in the data, with 32% on the first axis and 43% on the second axis. In this study, O. crassum was found to be more closely associated with manganese and aluminium and less associated with iron and zinc compared to K. acidophilum and M. quadrata (FIG. 2A). Similar PCA analyses were used to study the impact of metal absorption by algae at pH 7, 5 and 3 as shown in FIG. 2B. It was found that at pH 7 and pH 5 metals are readily available to be absorbed by algae in comparison to pH 3. Absorption of Mn and Al by algae was preferred at pH 7, absorption of Zn by algae is preferred at pH 5 and absorption of Fe by all three algae species is preferred at pH 3.

Sulphate, metals and sulphur-metal complex contaminated wastewater, produced by AMD and mineral processing, have been generates of many adverse effects e.g. the wastewaters negatively affect the aquatic ecosystem; the reduced products volatilize into the atmosphere and contribute to acid rain; the generated toxic acidic gas raises serious health risks to living beings and is corrosive to materials, which make it one of the mining industry's most significant environmental and financial liabilities. Many resource companies implement lime treatment to reduce the concentrations of metals and sulphate in wastewater; however, lime treatment can require additional process steps to produce water that complies with Water Research Commission (WRC), EPA and many other governmental regulations, and can create a metal-laden sludge that requires on-going storage and management, creating a long-term environmental liability for site owners and governments.

To date, substantial effort and skill have been employed to treat sulphate-rich wastewater. The techniques generally include precipitation (utilizes chemicals), membrane separation (such as reverse osmosis and electrodialysis with the disadvantages of energy costs and skilled labour), bioelectrochemical systems (coupled electrochemical and biological treatment that has been considered as an effective method for sulphate removal—disadvantages are that it requires skilled labour and has high maintenance costs), and biological methods (such as surface wetland/subsurface wetland and microbial ponds).

At present, biological methods are the most commonly used techniques for sulphate-rich wastewater treatment because of the relatively low cost, low skill labour force and energy consumption compared to physicochemical methods. In the biological methods, sulphate-reducing bacteria play important roles in sulphate reduction. Sulphate is reduced to sulfide by employing sulphate-reducing bacteria, and the sulfide is then oxidized to elemental sulfur deposits. Several species of sulphate-reducing bacteria, such as Desulfovibrio desulfuricans, Desulfuromonas acetoxidans, Desulfobulbus propionicus, have been confirmed with sulphate reduction. Sulphate-reducing bacteria are generally suitable for growth in neutral conditions of pH 6-8 and are sensitive to pH changes. In addition, the optimum pH for sulphate-reducing bacteria removing sulphate is neutral, i.e. about pH 7. However, the pH value of sulphate-rich AMD largely derived from acidic wastewater is usually around 3-4. Therefore, pH adjustment for wastewater is necessary in pretreatment process to increase treatment efficiency. Therefore, an alternative regime is required to overcome and improve sulphate reduction.

The inventors managed to identify three extremophilic green filamentous algae varieties, viz O. crassum, K. acidophilum and M. quadrata, which have a wide pH tolerance range (FIG. 3) and which can adapt to the winter conditions in South Africa. These algaes (macroalgaes) are efficient in heavy metal, trace metal and sulphate removal from acid mine water in wetlands, thus providing the option to utilize them in AMD remediation as part of passive phycobioremediation using agal ponds in conjunction with bacterial technology in constructed wetlands/ponds. Combination of these technologies may contribute to environmental, health, academic, industrial and governmental sectors and generate considerable revenue.

The association phenomena between the algae species to sulphur at different pH are unique and specific (FIG. 4). Association phenomena were analysed through principle component analysis. The ordination plot describes 100% of the variation in the data, with 60% on the first axis and 40% on the second axis. In this study, M. quadrata was found to be more closely associated with sulphur in comparison to K. acidophilum and O. crassum (FIG. 4a). Similar PCA analyses were used to study the impact of sulphur absorption by algae at pH 7, 5 and 3 as shown in FIG. 4b. It was found that absorption of sulphur by algae is independent of pH in comparison to metal absorption analysis.

To summarize, the experiments were conducted under different pH values, thereby mimicing different treatment plants producing different AMDs, to observe the macroalgal treatment effect under different pH values. Two studies were conducted to determine the suitability of macroalgae for passive treatment. In the field study macroalgae showed that bioconcentration of metals in the benthic river macroalgae mats was not related to the concentrations measured in the water column of AMD impacted sites, indicating that certain benthic macroalgae may have a greater preference for specific metals under different environmental conditions. The concentrations of metals as mg·kg⁻¹ dry weight measured in the field study at the different AMD sampling sites dominated by different macroalgae mats were in the follow order: site 1. O. crassum Al>Fe>Mn>Zn; site 2. K. acidophilum Al>Fe>Mn>Zn; site 3. M. quadrata, Fe>Al>Mn>Zn and site 4. M. quadrata, Fe>Mn>Al>Z. In the laboratory study, cultured macroalgae K. acidophilum, O. crassum and M. quadrata isolated from the field sampling sites were exposed to three different pH values, while biosorption of the metals, Al, Fe, Mn and Zn and glutathione-S-transferase (GST) activity was established between the different algae species at a constant temperature of 14° C. No significant difference between the isolated macroalgae species and the different pH ranges were observed in regards to GST activity. However a significant difference between GST activity in the control (saline, NaCl) and the AMD exposed (p<0.0001) macroalgae was observed. Individual types of metal biosorption of each macroalgae species differs at the different pH values. Al biosorption amongst the different macroalgae species were in the following order: O. crassum>K. acidophilum>M. quadrata (p<0.0001). No significant differences between Fe and macroalgae species were observed, however, biosorption significantly improved over the exposure time (p<0.000001) under low pH values (p=0.000157). From the study it was evident that the highest metal biosorption occurred in the macroalgae O. crassum at all three tested pH values under constant low water temperature. This makes O. crassum an ideal candidate for secondary passive treatment of AMD during winter months, when primary treatment of metals by constructed wetland is reduced due to lower water temperatures, while M. quadrata absorbs the highest sulphate (average 71%). It is thus believed that the combination of O. crassum and M. quadrata can be used for AMD treatment, to obtain both good metal removal and good sulphate removal.

The three macroalgae species, i.e. O. crassum, K. acidophilum and M. quadrata can be implemented as secondary passive treatment for AMD in accordance with the invention, as shown in FIG. 5.

In FIG. 5, reference numeral 10 generally indicates a process in accordance with the invention for treating AMD.

The process 10 includes a primary treatment stage 12 in the form of a neutralization vessel in which untreated or raw AMD, entering along line 14 and which is typically at a pH of about 3, is neutralized to a pH of about 7 by addition of lime entering the vessel 12 along a line 16. A major portion of dissolved metals such as Al, Fe, Mg, Mn and Zn precipitate out and are removed along a line 18. Neutralized AMD passes from the stage 12 along a line 20 to a conventional constructed surface flow wetland 22, where some more of the dissolved metals are removed.

Partially treated AMD passes from the wetland 22 along a line 24 to an algal finishing pond 26 which is at ambient water temperature, i.e. typically about 20° C. to 25° C. in summer and 10° C. to 15° C. in winter. The pond contains the macroalgae O. crassum, and M. quadrata and/or K. acidophilum. Further metal removal, as well as sulphate removal, is effected in the pond 26 by means of the macroalgae. The water residence time in the pond 26 is 24 to 96 hours, i.e. 1 to 4 days, for effective metal and sulphate removal. The algal level in the pond 26 is typically maintained at about 1×10⁵ cells/l.

Treated water passes from the pond 26 along a line 28 into a river stream 30.

Active treatment of mine water is quite demanding in chemical use, energy input and skilled manpower which are in a shortage in South Africa. As a result, passive treatment which involves self-operating systems may be the way forward in future. From this study, it was evident that certain species of benthic filamentous algae can play an important role as part of passive treatment technology by absorbing metals during winter months when environmental conditions are more unfavourable for macrophytes in constructed wetlands.

### REFERENCES

American Public Health Association (APHA), (1992), American Water Works Association (AWWA), and Water Pollution Control Federation (WPCF) Standard Methods for the Examination of Water and Wastewater (19th ed.)APHA, AWWA, and WPCF, Washington, D.C., USA
Clesceri L., Greenberg A. E., Eaton, A. D., (1998) Standard Methods for Examination of Water and Wastewater. APHA-AWWA-WEF. Washington, D.C.
Davis J. C. 1973. Statistics and data analysis in geology, John Wiley Sons, inc., New York, 550 p.
Douglas, B. (1958). The ecology of the attached diatoms and other algae in a small stony stream. J of Ecol 46: 295-322.
Hauer, F. R., Lamberti, G. A. (2006). Methods in stream ecology. Elsevier, Academic Press, Amsterdam, pp. 357-377.
Jones, B R and Laslett, R E. (1994) Methods for analysis of trace metals in marine and other samples. Aquatic Environment Protection: Analytical methods No 11. Directorate of fisheries Research, Ministry for Agriculture, Food and Fisheries. UK.
Jugdaohsingh, R., Campbell, M. M., Thompson, R. P. H., McCrohan, C. R., White, K. N., Powell, J. J., (1998). Mucus secretion by the freshwater snail Lymnaea stagnalis limits aluminium concentration of the aqueous environment. Environ Sci Technol 32, 2591-2595.
Mozer, T. J., Tiemeier, D. C., Jaworski, E. G., 1983. Purification and characterization of corn glutathione S-transferase. Biochemistry. 22 (5), 1068-1072.
Porra, R. J., Thompson, W. A., Kriedemann, P. E., 1989. Determination of accurate extinction coefficient and simultaneous equations for assaying chlorophylls a and b extracted with four different solvents: verification of the concentration of chlorophyll standards by atomic absorption spectrometry. Biochimica et Biophysica Acta 975 (3), 384-394.
Regoli, F., Abele, D., Vázquez-Medina, J. P., Zenteno-Zavín, T., 2012. Oxidative Stress in Aquatic Ecosystems, Wiley-Blackwell, a John Wiley & Sons, Ltd., UK, (Eds.), pp. 308-316
Swain, T., 1977. Secondary compounds as protective agents. Annual Review of Plant Physiology. 28, 479-501
Ter Braak, C. J. F. \check{S}milauer P. (2002). CANOCO Reference Manual and Canodraw for Windows User's Guide: Software for Canonical Community Ordination (Version 4.5) Microcomputer Power, New York, USA
Truter, E., 1987. An aid to the identification of the dominant and commonly occurring genera of algae observed in some South African impoundments, Department of Water Affairs, Private Bag x313 Pretoria, South Africa, ISBN 0621 11510X, pp. 1-97.
Van Vuuren, S. Taylor, J. C. Gerber, A. Van Ginkel. C. (2006). Easy Identification of the Most Common Freshwater Algae North-West University and Department of Water Affairs and Forestry, Pretoria, South Africa pp. 1-200
Vega-López, A., Ayala-López, G., Posadas-Espadas., B. P., Olivares-Rubio, H. F., Dzul-Caamal, R., 2013. Relations of oxidative stress in freshwater phytoplankton with heavy metals and polycyclic aromatic hydrocarbons. Comparative Biochemistry and Physiology Part A: Molecular & Integrative Physiology 165 (4), 498-507.

1. A biological process for treating metal- and/or sulphate-containing waste water, the process including
introducing at least one macroalgal species selected from Klebsormidium acidophilum, Microspora quadrata and Oedogonium crassum, into a body of water;
introducing the waste water into the body of water; and
in a water treatment stage, allowing the macroalgal species to biosorb at least one metal and/or at least one sulphate from the waste water, thereby to bioremediate the waste water.

2. The biological process according to claim 1, wherein the waste water is acid mine drainage (AMD) containing both dissolved metals and dissolved sulphates.

3. The biological process according to claim 2, wherein the body of water is provided downstream of at least one other water treatment stage.

4. The biological process according to claim 3, wherein two other water treatment stages are provided, with untreated AMD being subjected, in a first of the water treatment stages, to primary treatment to remove some dissolved metals therefrom, and with the AMD from the first water treatment stage then being subjected, in a second of the water treatment stages, to secondary treatment to remove further dissolved metals therefrom, with the resultant partially treated AMD then passing from the second treatment stage into the body of water, and with the biosorption of the at least one metal and the at least one sulphate thus constituting tertiary treatment of the AMD.

5. The biological process according to claim 4, wherein the primary treatment comprises raising the pH of the AMD to about 5 to 7 in order to precipitate dissolved metals present in the AMD.

6. The biological process according to claim 5, wherein the raising of the pH is effected in a neutralization stage in which the AMD is treated with lime in order to raise its pH.

7. The biological process according to claim 4, wherein the secondary treatment comprises passing the AMD through a wetland for further removal of metals therefrom, with the wetland thus constituting the second of the water treatment stages.

8. The biological process according to claim 7, wherein the wetland is a constructed artificial wetland.

9. The biological process according to claim 4, wherein the tertiary treatment is effected in an algal polishing pond which thus provides the body of water in which the treatment with the K. acidophilum, M. quadrata and O. crassum takes place.

10. The biological process according to claim 9, wherein the macroalgal concentration in the algal polishing pond is maintained at about 1×10⁵ cells/l.

11. The biological process according to claim 9, wherein the residence time of the partially treated AMD in the algal polishing pond is at least one hour.

12. The biological process according to claim 11, wherein the residence time of the partially treated AMD in the algal polishing pond is from 24 to 96 hours.

13. A biological process for treating acid mine drainage (AMD), the process including
subjecting, in a first water treatment stage, AMD to primary treatment to remove dissolved metals therefrom;
subjecting the AMD from the first water treatment stage, to secondary treatment in a second water treatment stage, to further remove dissolved metals therefrom; and
introducing the resultant partially treated AMD into a body of water containing at least one macroalgal species selected from Klebsormidium acidophilum, Microspora quadrata and Oedogonium crassum, for tertiary treatment of the AMD to remove dissolved metals and sulphates therefrom.

14. The biological process according to claim 13, wherein the primary treatment comprises raising the pH of the AMD to about 5 to 7 in order to precipitate dissolved metals present in the AMD.

15. The biological process according to claim 14, wherein the raising of the pH is effected in a neutralization stage in which the AMD is treated with lime in order to raise its pH.

16. The biological process according to claim 13, wherein the secondary treatment comprises passing the AMD through a wetland for further removal of metals therefrom, with the wetland thus constituting the second water treatment stage.

17. The biological process according to claim 16, wherein the wetland is a constructed artificial wetland.

18. The biological process according to claim 13, wherein the tertiary treatment is effected in an algal polishing pond which thus provides the body of water in which the treatment with the K. acidophilum, M. quadrata and O. crassum takes place.

19. The biological process according to claim 18, wherein the macroalgal concentration in the algal polishing pond is maintained at about 1×10⁵ cells/l.

20. The biological process according to claim 18, wherein the residence time of the partially treated AMD in the algal polishing pond is at least one hour.

21. (canceled)
